(19) United States
(12) Patent Application Publication
(10) Pub. No.: US 2026/0193919 A1
(43) Pub. Date: Jul. 9, 2026

(54) GUIDE SYSTEM FOR GUIDING AT LEAST ONE MOVABLY MOUNTED DOOR LEAF ALONG A FURNITURE WALL

(71) Applicant: Julius Blum GmbH, Hoechst (AT)

(72) Inventors: André HAMMERER, Alberschwende (AT); Matthias JAEGER, Dornbirn (AT); Lukas KOLHAUPT, Lauterach (AT); Lukas SCHREIBER, Feldkirch (AT)

(21) Appl. No.: 19/552,645

(22) Filed: Feb. 27, 2026

Related U.S. Application Data
(63) Continuation of application No. PCT/AT2024/060308, filed on Aug. 14, 2024.

(30) Foreign Application Priority Data
Sep. 7, 2023 (AT) A 50713/2023

(51) Int. Cl. E05D 15/58

(52) U.S. Cl. CPC E05D 15/58; E05D 2015/586; E05Y 2201/654; E05Y 2201/668; E05Y 2900/212

(57) ABSTRACT

A guide system for guiding a movably-supported door wing along a furniture wall, includes a first guide rail to be fixed to the furniture wall, a second guide rail to be fixed to the furniture wall at a vertical distance from the first guide rail, a carrier for pivotally supporting the door wing, a first guide device for movably supporting the carrier along the first guide rail, a second guide device for movably supporting the carrier along the second guide rail, and a cable pulley device for compensating for a tilting moment of the carrier about a tilting axis by a return moment. The cable pulley device includes a, preferably precisely one, cable which is crosswise guided via at least two deflection rollers arranged on the two guide devices and/or on the carrier.

The present application is a continuation of International Application PCT/AT2024/060308 filed on Aug. 14, 2024. Thus, all of the subject matter of International Application PCT/AT2024/060308 is incorporated herein by reference.

### BACKGROUND OF THE INVENTION

The present invention relates to a guide system for guiding at least one movably-supported door wing along a furniture wall, the guide system comprising:
a first guide rail to be fixed to the furniture wall,
at least a second guide rail to be fixed to the furniture wall at a vertical distance from the first guide rail,
a carrier for pivotally supporting the at least one door wing,
at least a first guide device for movably supporting the carrier along the first guide rail,
at least a second guide device for movably supporting the carrier along the second guide rail, and
a cable pulley device for compensating for a tilting moment of the carrier about a tilting axis by a return moment.

Such guide systems are usually used to guide at least one door wing which can be inserted in a depth direction of the item of furniture along a sidewall into a furniture carcass, or into a receiving compartment located on the side of the furniture carcass.

A particular challenge when guiding such a door wing is that the door wing tends to perform a tilting movement due to the weight force. This tilting of the door wing also causes an inclined position of the carrier and the two guide devices to tilt, and the guide devices can get jammed with their associated guide rails. In the event of such a jamming, a movement of the door wing is impossible or at least significantly impeded. Therefore, a primary goal is to ensure that the two guide devices are guided relative to their associated guide rails in a way that prevents them from tilting as much as possible.

Guide systems for a door wing with a cable pulley device for guiding a door wing in a tilting-free manner are disclosed, for example, in US 2007/0159037A1 (FIG. 4), WO 2018/129568 A1 (FIG. 5a), DE 197 09 461 A1 (FIG. 5), EP 1 394 349 A1 (FIG. 1) and in EP 0 128 503 A1 (FIG. 3). In order to improve the stability of the two guide devices relative to each other, a crosswise cable guidance is advantageous, for which at least two cables are provided. However, the installation of two cables is complicated to accomplish for an assembling person, and also involves an increased component expenditure.

### SUMMARY OF THE INVENTION

It is an object of the present invention to propose a guide system mentioned in the introductory part, thereby avoiding the above-discussed drawbacks.

According to the invention, the cable pulley device includes at least one, preferably precisely one, cable which is crosswise guided via at least two deflection rollers arranged on the two guide devices and/or on the at least one carrier.

Although the prior art mentioned in the introductory part provides for a crosswise cable guidance, at least two cables are required for this purpose. In contrast, with the present invention, basically one single cable is sufficient to form a cross in the cable guidance. In this way, the installation of the cable pulley device can be significantly facilitated.

The item of furniture according to the invention comprises a furniture carcass, at least one door wing movable relative to the furniture carcass, and at least one guide system of the type in question.

### BRIEF DESCRIPTION OF THE DRAWINGS

Further details and advantages of the present invention will be apparent from the following description with reference to the drawings, in which:

FIGS. 1a, 1b are perspective views of an item of furniture comprising a furniture carcass and door wings movable relative thereto,

FIGS. 2a, 2b show the item of furniture according to FIGS. 1a, 1b with the door wings in further positions relative to each other,

FIG. 3 shows the guide system in a perspective view,

FIG. 4 shows the guide system in a schematic side view,

FIG. 5 shows the guide system with the cable pulley device in a schematic side view,

FIGS. 6a, 6b show the cable pulley device in a perspective view and an enlarged detail view thereof,

FIGS. 7a, 7b show the cable pulley device in a further perspective view and an enlarged detail view thereof, and

FIGS. 8a, 8b show two different embodiments of an inclination adjustment device for adjusting an inclination of the carrier relative to a vertical.

### DETAILED DESCRIPTION OF THE INVENTION

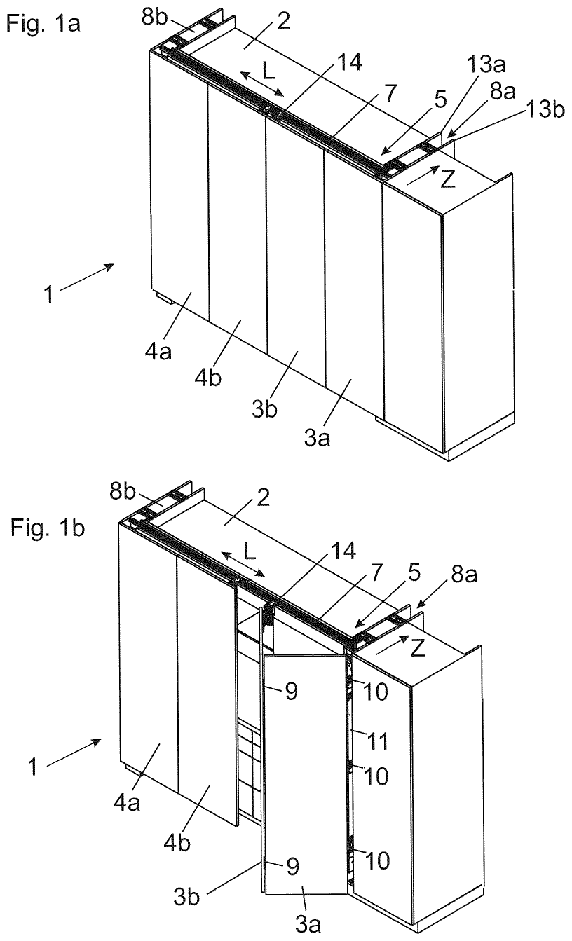

FIG. 1a shows a perspective view of an item of furniture 1 comprising a furniture carcass 2 and at least one door wing 3a, 3b; 4a, 4b movably-supported relative to the furniture carcass 2.

In the shown embodiment, a folding-sliding-door is provided, in which the door wing 3a and the door wing 3b are hingedly connected to each other via a vertically extending first pivoting axis. The two other door wings 4a, 4b are hingedly connected to each other via a vertically extending second pivoting axis.

The door wings 3a, 3b and the door wings 4a, 4b are each movable by a guide system 5 between a first position, in which the door wings 3a, 3b; 4a, 4b are aligned substantially coplanar to each other, and a second position, in which the door wings 3a, 3b; 4a, 4b are aligned substantially parallel to each other.

In a second (parallel) position, the door wings 3a, 3b can be inserted into a lateral receiving compartment 8a of the furniture carcass 2, whereas the two other door wings 4a, 4b, in a parallel position to each other, can be inserted into a further receiving compartment 8b.

The functionality will be explained in the following with the aid of the door wings 3a and 3b, and the same explanations are valid for the door wings 4a, 4b.

The guide system 5 includes a guide 7 having a longitudinal direction L, and a running carriage 14 configured to be coupled to the second door wing 3b is displaceably supported along the guide 7. In a mounted position, the guide 7 is aligned substantially horizontally and parallel to a front edge of the furniture carcass 2.

Preferably, the guide 7 is configured as a guide rail.

FIG. 1b shows the item of furniture 1, in which the door wings 3a, 3b have been moved from the coplanar position shown in FIG. 1a into an angled position relative to each other.

For example, the first door wing 3a can be pivotally supported on a carrier 11 via two or more furniture hinges 10, and the carrier 11 (jointly with the two door wings 3a, 3b) is insertable in the depth direction Z into the receiving compartment 8a.

The carrier 11, in the shown figure, is located in a transfer position in which the carrier 11 adjoins the guide 7 in the longitudinal direction L such that the running carriage 14 can be transferred to and from between the guide 7 and the carrier 11.

In the shown transfer position, the carrier 11 is releasably locked relative to the guide 7, and the locking of the carrier 11 is releasable by an entry of the running carriage 14 in or onto the carrier 11.

The carrier 11 is in the form of a longitudinally extending column, the length of which corresponding to at least half of a height of the door wings 3a, 3b.

The two door wings 3a, 3b are hingedly connected to each other via at least one hinge fitting 9 and are pivotable about a vertically extending pivoting axis in the mounted position. The second door wing 3b is displaceably guided along the guide 7 via the running carriage 14.

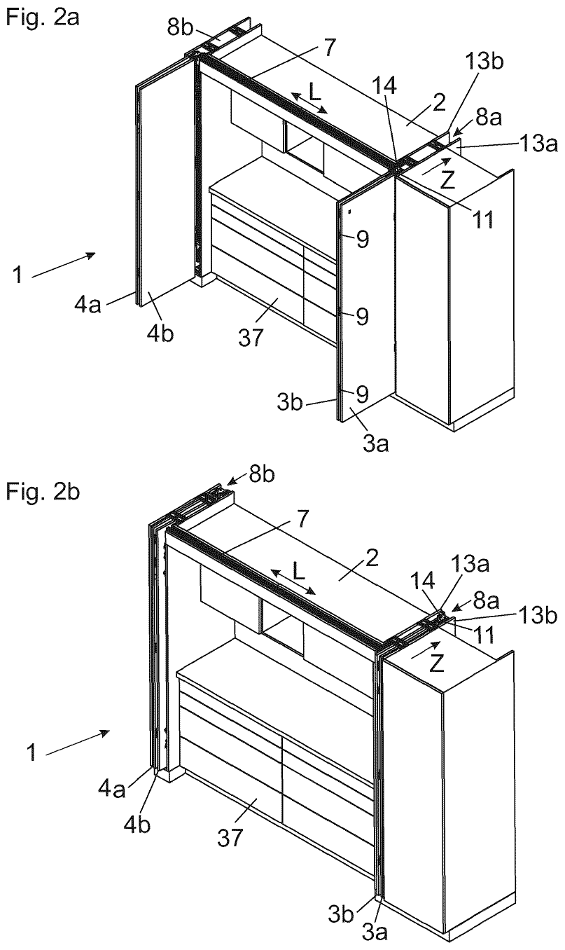

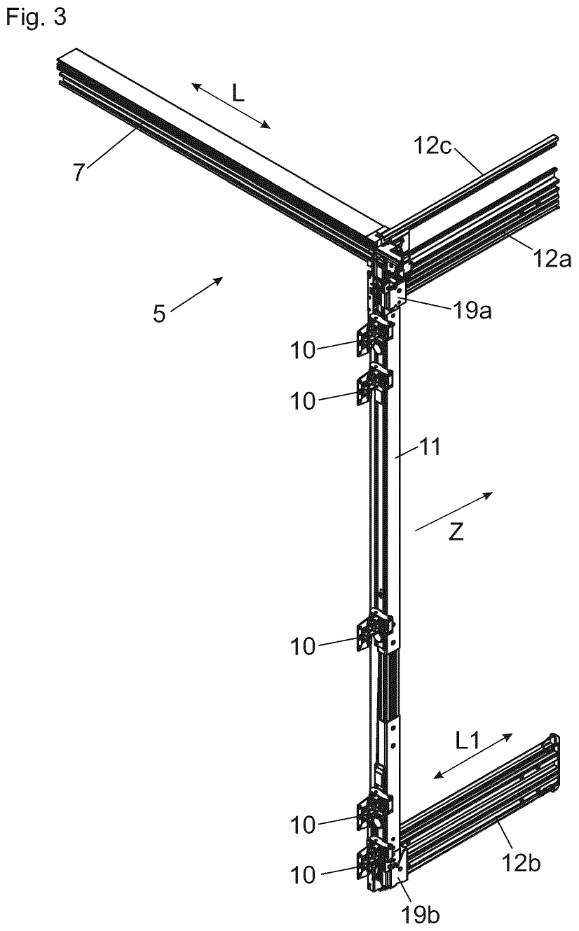

FIG. 2a shows the item of furniture 1 with the door wings 3a, 3b which are now aligned parallel to each other. The carrier 11 has been unlocked from the guide 7 by an entry of the running carriage 14, so that the carrier 11 (jointly with the running carriage 14 and the door wings 3a, 3b) is insertable in the depth direction Z along at least two guide rails 12a, 12b (FIG. 3) of the guide system 5 into the receiving compartment 8a, the two guide rails 12a, 12b being spaced apart from each other in a height direction.

FIG. 2b shows the item of furniture 1 with the door wings 3a, 3b which are now located in a fully inserted condition within the receiving compartment 8a. Accordingly, the door wings 3a, 3b are movably supported by the guide system 5 between a first position according to FIG. 1a, in which the door wings 3a, 3b are aligned substantially coplanar to each other, and a second position according to FIG. 2b, in which the door wings 3a, 3b are aligned substantially parallel to each other and can be received within the receiving compartment 8a.

In this way, for example, a kitchen 37 as shown in FIGS. 2a, 2b can be entirely covered, so that the kitchen 37 can be visually separated from a remaining area of a living room.

The receiving compartment 8a, in the shown embodiment, is formed by a first furniture wall 13a and by a second furniture wall 13b spaced apart from the first furniture wall 13a in a substantially parallel relationship, and the door wings 3a, 3b can be received between the two furniture walls 13a, 13b when aligned parallel to each other.

FIG. 3 shows the guide system 5 in a perspective view. By the guide 7, the door wings 3a, 3b can be guided along a front side of the furniture carcass 2.

The carrier 11 is configured for pivotally supporting the first door wing 3a and can include at least one furniture hinge 10 or a plurality of furniture hinges 10 spaced apart from each other in a longitudinal direction of the carrier 11.

The carrier 11 is displaceably supported along a first guide rail 12a via a first guide device 19a, and is displaceably supported along a second guide rail 12b in the depth direction Z via a second guide device 19b.

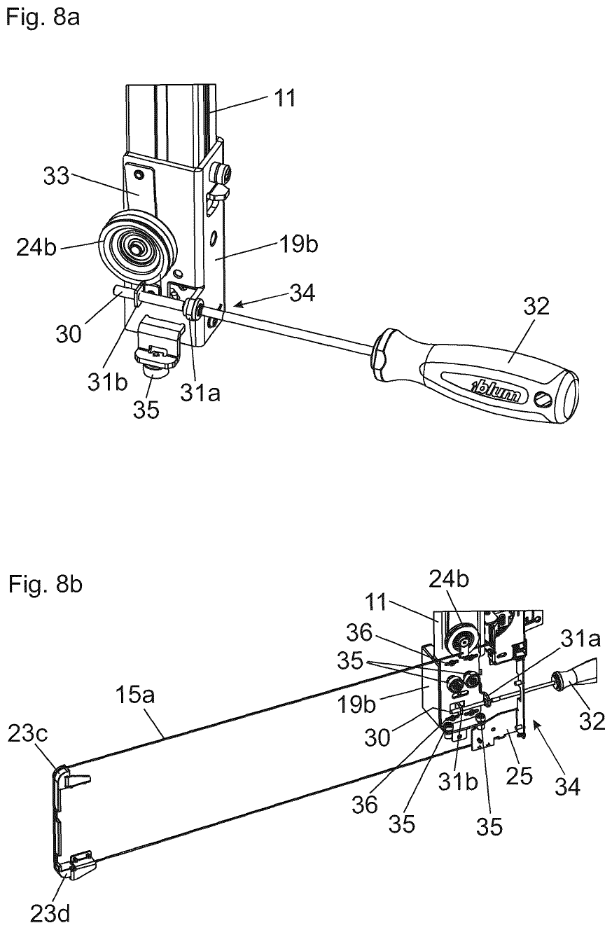

The carrier 11 and/or the guide devices 19a, 19b can include at least one rolling body 35 (FIG. 8a, FIG. 8b) displaceably supported along a guide rail 12a, 12b.

Preferably, the carrier 11 and/or the guide devices 19a, 19b includes or include a plurality of rolling bodies 35, the rolling bodies 35 being rotationally supported about a horizontally extending axis in the mounted position and/or about a vertically extending axis in the mounted position and are configured to run along a guide rail 12a, 12b.

In the shown embodiment, at least one further guide rail 12c is provided, the further guide rail 12c being spaced apart from the two guide rails 12a, 12b in a height direction. Each of the guide rails 12a, 12b, 12c has a longitudinal direction L1.

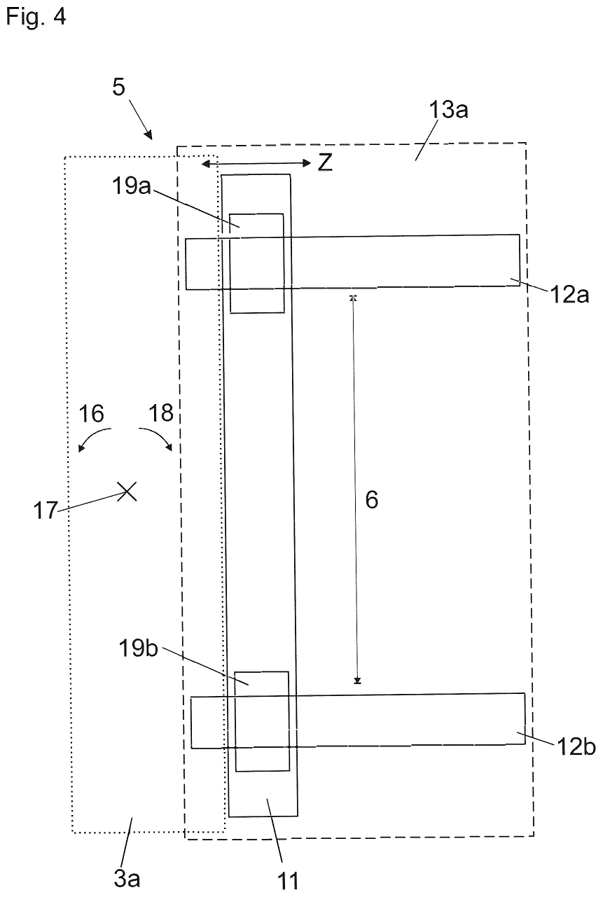

FIG. 4 shows a schematic side view of the guide system 5, in which the first guide rail 12a and the second guide rail 12b are fixed to the furniture wall 13a. The second guide rail 12b is arranged on the furniture wall 13a at a vertical distance 6 from the first guide rail 12a.

The carrier 11 is movably supported in the depth direction Z along the first guide rail 12a via the first guide device 19a, and is movably supported along the second guide rail 12b via the second guide device 19b.

The at least one door wing 3a is pivotally supported on the carrier 11, and the door wing 3a is indicated with a dashed line. The carrier 11 is connected to the two guide devices 19a, 19b in a movement-coupled manner.

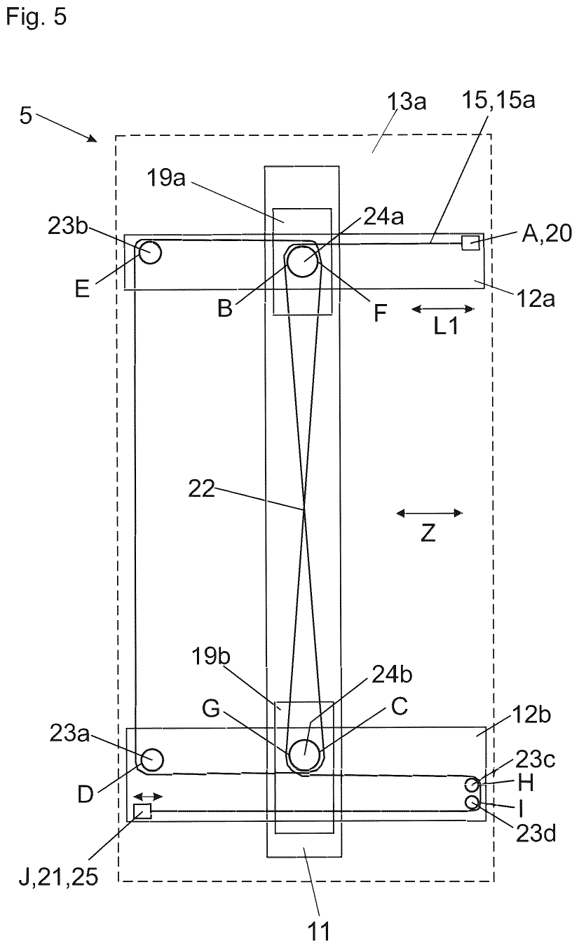

Further, a cable pulley device 15 (FIG. 5) for compensating for a tilting moment 16 of the carrier 11 about a tilting axis 17 by a return moment 18 is provided. When the carrier 11 or the door wing 3a is aligned vertically, the tilting axis 17 is aligned horizontally.

The cable pulley device 15 thus ensures that the at least one door wing 3a is stably guided in each position, without the guide devices 19a, 19b tilting relative to the guide rails 12a, 12b.

FIG. 5 shows a schematic side view of the guide system 5. The carrier 11 is movably supported in the depth direction Z between a retracted end position and an extended end position along the two guide rails 12a, 12b.

In the shown figure, the carrier 11 is located approximately in a middle position between the retracted end position and the extended end position. The carrier 11 is movably supported along the guide rails 12a, 12b via the two guide devices 19a, 19b.

At least two deflection rollers 24a, 24b for at least one, preferably precisely one, cable 15a of the cable pulley device 15 are rotationally supported on the carrier 11 and/or on the guide devices 19a, 19b.

Reference numerals 23a, 23b, 23c, 23d denote deflection elements. The cable 15a is stationarily arranged on the deflection elements 23a, 23b, 23c, 23d, that is to say that substantially no relative movement occurs between the cable 15a and the deflection elements 23a, 23b, 23c, 23d upon a movement of the carrier 11 along the guide rails 12a, 12b. The deflection elements 23a, 23b, 23c, 23d are arranged on the guide rails 12a, 12b.

The cable 15a is guided crosswise on the two deflection rollers 24a, 24b arranged on the two guide devices 19a, 19b and/or on the at least one carrier 11. As a result, a substantially tilting-free movement of the carrier 11 and of the guide devices 19a, 19b can be ensured.

The cable 15a of the cable pulley device 15, in the shown embodiment, is guided as follows:
a first cable end 20 of the cable 15a is arranged, preferably stationarily, on the first guide rail 12a on the location A,
the cable 15a is guided around the first deflection roller 24a on the location B,
the cable 15a is guided around the second deflection roller 24b on the location C,
the cable 15a is guided around the first deflection element 23a on the location D,
the cable 15a is guided around the second deflection element 23b on the location E,
the cable 15a is guided around the first deflection roller 24a on the location F,
the cable 15a is guided around the second deflection roller 24b on the location G,
the cable 15a is guided around the third deflection element 23c on the location H,
the cable 15a is guided around the fourth deflection element 23d on the location I,
a second cable end 21 of the cable 15a is arranged, preferably in an adjustable manner, on the second guide rail 12b on the location J.

In order to adjust a tension of the cable 15a, at least one adjustment device 25 can be provided. By the adjustment device 25, the two cable ends 20, 21 of the cable 15a can be tensioned relative to each other. In the shown embodiment, the adjustment device 25 is arranged on the second guide rail 12b.

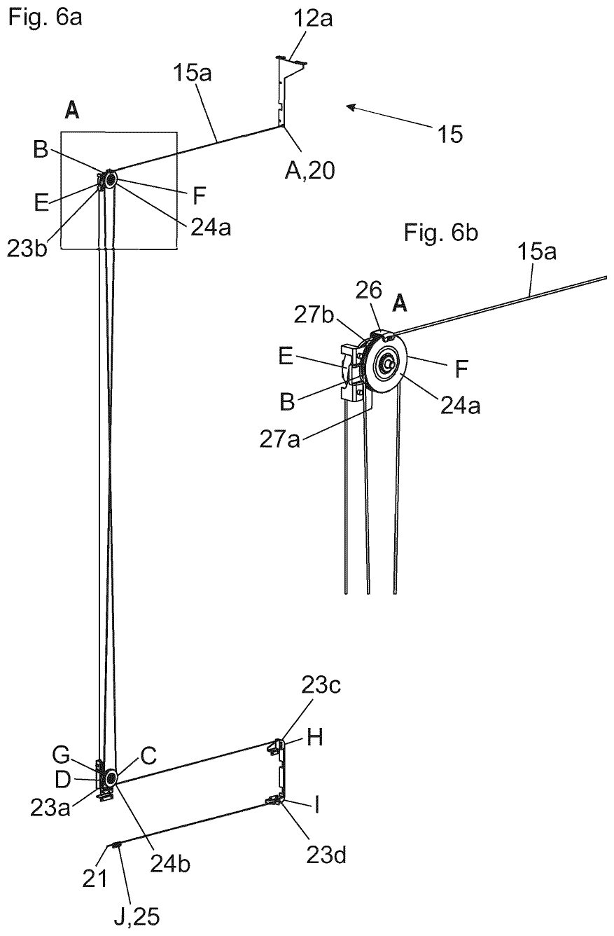

In order for the cable 15a to be guided twice around the two deflection rollers 24a, 24b, the two deflection rollers 24a, 24b include two guide grooves 27a, 27b (FIG. 6b) extending substantially parallel to each other for guiding the cable 15a. A first cable portion of the cable 15a is guided in a first of the two guide grooves 27a, 27b, and a second cable portion is guided in a second of the two guide grooves 27a, 27b.

According to possible embodiments, the cable 15a:
has a crossing point 22 arranged substantially in the middle of the at least one carrier 11, and/or
includes at least one cable portion which is guided, preferably stationarily, between the two guide rails 12a, 12b in a direction extending substantially parallel to the carrier 11 (cable portion between location D and location E), and/or
includes at least one cable portion which is guided in a direction extending substantially parallel to a longitudinal direction L1 of the first and second guide rail 12a, 12b (cable portion between location A and location B, cable portion between location C and location D, cable portion between location E and location F, cable

portion between location G and location H, cable portion between location I and location J).

Upon a movement of the carrier 11 between the retracted end position and the extended end position, the carrier 11 is guidable along at least one cable portion extending substantially in a direction parallel to the longitudinal direction L1 of the first end second guide rail 12a, 12b.

The cable 15a includes a first cable end 20 arranged on a first end of the first guide rail 12a. A second cable end 21 of the cable 15a is arranged on a first end of the second guide rail 12b.

According to possible embodiments:
the first end of the first guide rail 12a and the first end of the second guide rail 12b are arranged diametrically opposed to each other, and/or
a position of at least one of the two cable ends 20, 21 relative to the first or second guide rail 12a, 12b is adjustable by an adjustment device 25, and/or
at least one of the two cable ends 20, 21 is fixed in position to one of the guide rails 12a, 12b.

According to an embodiment, the cable 15a is guided such that the cable 15a, in a side view onto the furniture wall 13a, forms a first Z-shape and at least a second Z-shape. Preferably, the two Z-shapes are arranged mirror-symmetrical to each other.

FIG. 6a shows the cable pulley device 15 according to FIG. 5 in a perspective view, in which the first cable end 20 of the cable 15a is fixed to the first guide rail 12a on the location A.

The cable 15a, as already described, is guided around the locations B-I around the deflection rollers 23a-23d and around the deflection elements 23a-23d. The second cable end 21 is held on the location J on the first guide rail 12b, and a tension of the cable 15a is adjustable by an adjustment device 25.

According to an embodiment, the cable 15a can include at least one cable portion which is guided around at least one of the two guide rails 12a, 12b in a substantially U-shaped manner. In the present case, the cable 15a is guided around the second guide rail 12b in a substantially U-shaped manner.

Basically, it is not strictly necessary to guide the cable 15a around the two deflection elements 23c, 23d. However, this measure is advantageous, because a reserve cable is available in this way, and the tensioning of the cable 15a can be easily done by the adjustment device 25.

FIG. 6b shows the framed region of FIG. 6a in an enlarged view. The deflection roller 24a and/or the deflection roller 24b includes or include at least two guide grooves 27a, 27b for guiding the cable 15a, the guide grooves 27a, 27b extending substantially parallel to

each other. Thereby, the cable 15a is guided in a first of the two guide grooves 27a, 27b with a first cable portion, and is guided in a second of the two guide grooves 27a, 27b with a second cable portion.

The deflection rollers 24a, 24b and/or the deflection elements 23a-23d can include at least one, preferably pivotable, safety bracket 26, the safety bracket 26 being configured to prevent an escape of the cable 15a from the deflection rollers 27a, 27b and/or from the deflection elements 23a-23d.

Preferably, the cable 15a is deflected on at least one deflection roller 24a, 24b, preferably on both deflection rollers 24a, 24b, once, preferably twice, by substantially 90°.

With a further embodiment, the cable 15a is deflected on at least one deflection element 23a-23d, preferably on all deflection elements 23a-23d, by substantially 90°.

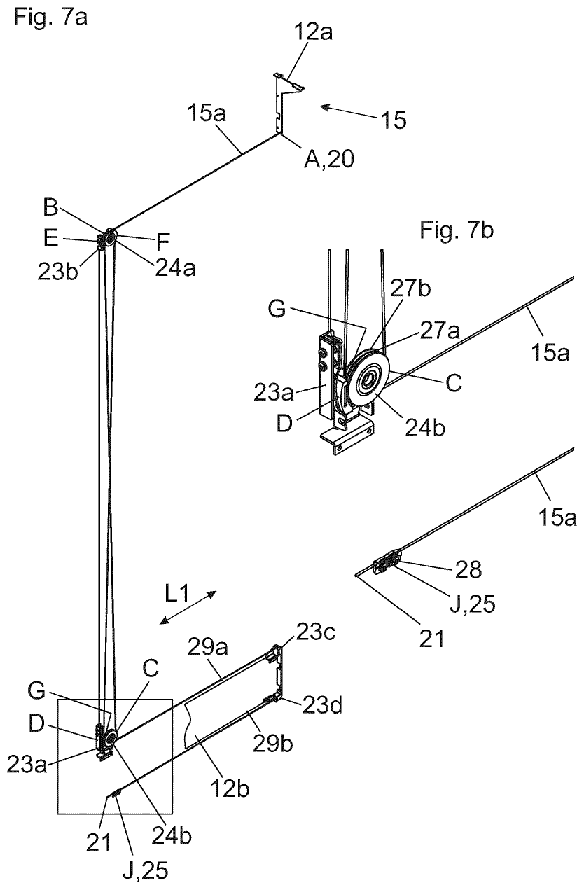

FIG. 7a shows the cable pulley device 15 in a further perspective view.

According to possible embodiments, the cable 15a of the cable pulley device 15
includes at least one cable portion which is guided along a first longitudinal edge 29a of the second guide rail 12b and along a second longitudinal edge 29b of the

second guide rail 12b, the first longitudinal edge 29a and the second longitudinal edge 29b being spaced apart from each other in a direction extending transversely to the longitudinal direction L1 of the second guide rail 12b, and/or
includes at least one cable portion which is guided around at least one of the two guide rails 12a, 12b in a substantially U-shaped manner.

FIG. 7b shows the framed region of FIG. 7a in an enlarged view. The second (lower) deflection roller 24b can also include at least two guide grooves 27a, 27b for guiding the cable 15a, the guide grooves 27a, 27b extending substantially parallel to each other. A first cable portion of the cable 15a is guided in a first guide groove 27a, and a second cable portion of the cable 15a is guided in the second guide groove 27b.

The adjustment device 25 on the location J for adjusting a tension of the cable 15a can include at least one rotatable adjustment element 28, for example in the form of a clamping screw. However, it is also possible that the adjustment element 28 forms part of a worm gear, and a tension of the cable 15a is variably adjustable by rotating the adjustment element 28.

FIG. 8a shows a first embodiment of an inclination adjustment device 34 for adjusting an inclination of the carrier 11 relative to a vertical. The inclination adjustment device 34 serves for correcting a possible malposition of the carrier 11 and/or for correcting a possible malposition of the door wing 3a which is pivotally supported on the carrier 11.

Preferably, the inclination adjustment device 34 is arranged on the second (lower) guide device 19b. The first (upper) guide device 19a itself does not have an inclination adjustment device 34.

The inclination adjustment device 34 includes at least one threaded portion 30 which is in a threading engagement with a bearing 31a of the second (lower) guide device 19b and with a counter bearing 31b. The counter bearing 31b is arranged on a pivoting lever 33 on which the (lower) deflection roller 24b is also supported. In the mounted position, the second deflection roller 24b is stationarily held in its position due to the cable 15a guided in a doubled manner.

Upon a rotation of the threaded portion 30 with the aid of a tool, for example a screwdriver, the guide device 19b (and therewith the carrier 11) is movable relative to the stationarily-held second deflection roller 24. As a result, the position of the carrier 11 relative to a vertical is also adjustable.

The first guide device 19a and/or the second guide device 19b includes or include at least one rolling body 35 so as to run along a guide rail 12a, 12b.

Preferably, each of the first guide device 19a and/or the second guide device 19b includes a plurality of rolling bodies 35 having a horizontally extending rotational axis and/or a vertically extending rotational axis.

FIG. 8b shows the inclination adjustment device 34 according to a further embodiment. Here, a threaded portion 30 is also provided, the threaded portion 30 being in a threading engagement with a bearing 31a of the second guide device 19b and with a counter-bearing 31b arranged on the carrier 11.

In a mounted position, the second deflection roller 24b is stationarily held in its position due to the cable 15a guided in a doubled manner.

Upon rotating the threaded portion 30 with the aid of a tool 32, preferably a screwdriver, the relative position between the second guide device 19b and the carrier 11 is adjustable via at least one linear guide 36, preferably via a plurality of linear guides 36.

In the shown embodiment, the at least one linear guide 36 includes an elongated hole arranged on the second guide device 19b, and a guide element (for example a pin) arranged on the carrier 11 is displaceably guided in the elongated hole.

In a kinematic reversal, it is also possible to form or to arrange the elongated hole on the carrier 11, and the guide element engaging in the elongated hole on the guide device 19b.

1. A guide system for guiding at least one movably-supported door wing along a furniture wall, the guide system comprising:
a first guide rail to be fixed to the furniture wall,
at least a second guide rail to be fixed to the furniture wall at a vertical distance from the first guide rail,
a carrier for pivotally supporting the at least one door wing,
a first guide device for movably supporting the carrier along the first guide rail,
a second guide device for movably supporting the carrier along the second guide rail,
a cable pulley device for compensating for a tilting moment of the carrier about a tilting axis by a return moment,
wherein the cable pulley device includes at least one, preferably precisely one, cable, wherein the cable is crosswise guided via at least two deflection rollers arranged on the two guide devices and/or on the at least one carrier.

2. The guide system according to claim 1, wherein the cable:
has a crossing point arranged substantially in the middle of the at least one carrier, and/or
includes at least one cable portion which is guided, preferably stationarily, between the two guide rails in a direction extending substantially parallel to the carrier.

3. The guide system according to claim 1, wherein the cable:
includes at least one cable portion which is guided in a direction extending substantially parallel to a longitudinal direction of the first and second guide rail, and/or
includes at least one cable portion which is guided along a first longitudinal edge of the second guide rail, and along a second longitudinal edge of the second guide rail, the first longitudinal edge and the second longitudinal edge being spaced apart from each other in a direction extending transversely to the longitudinal direction of the second guide rail, and/or
includes at least one cable portion which is guided around at least one of the two guide rails in a substantially U-shaped manner.

4. The guide system according to claim 1, wherein the cable has a first cable end arranged on a first end of the first guide rail, and a second cable end arranged on a first end of the second guide rail, preferably wherein:
the first end of the first guide rail and the first end of the second guide rail are arranged diametrically opposed to each other, and/or
a position of at least one of the two cable ends relative to the first or second guide rail is adjustable by an adjustment device, and/or
at least one of the two cable ends is fixed in position to one of the two guide rails.

5. The guide system according to claim 1, wherein at least one deflection roller, preferably both deflection rollers, includes or include two guide grooves for guiding the cable, the guide grooves extending substantially parallel to each other, preferably wherein the cable is guided in a first of the two guide grooves with a first cable portion, and is guided in a second of the two guide grooves with a second cable portion.

6. The guide system according to claim 1, wherein the cable is deflected on at least one deflection roller, preferably on both deflection rollers, once, preferably twice, by substantially 90°.

7. The guide system according to claim 1, wherein at least one inclination adjustment device is provided for adjusting an inclination of the carrier relative to a vertical, preferably wherein the inclination adjustment device is configured to adjust a position of the at least one deflection roller relative to the carrier and/or relative to one of the guide devices.

8. The guide system according to claim 7, wherein the inclination adjustment device includes at least one threaded portion which is in a threading engagement with a bearing and with a counter-bearing, preferably wherein the bearing is arranged on one of the guide devices, and the counter-bearing is arranged on the carrier or on a pivoting lever supported on one of the guide devices.

9. The guide system according to claim 1, wherein at least one deflection element, preferably a plurality of deflection elements, is provided on which the cable is stationarily deflected, preferably by substantially 90°.

10. The guide system according to claim 1, wherein the cable is guided such that the cable, in a side view onto the furniture wall, forms a first Z-shape and at least a second Z-shape, preferably wherein the two Z-shapes are arranged mirror-symmetrical to each other.

11. The guide system according to claim 1, wherein at least one deflection roller, preferably both deflection rollers, includes or include at least one, preferably pivotable, safety bracket, wherein the at least one safety bracket is configured to prevent an escape of the cable from the deflection rollers.

12. The guide system according to claim 1, wherein at least one guide device, preferably both guide devices, includes or include at least one rolling body configured to run along one of the guide rails.

13. The guide system according to claim 1, wherein the carrier includes at least one furniture hinge, preferably a plurality of furniture hinges, for pivotally supporting the at least one door wing.

14. An item of furniture comprising:
a furniture carcass,
a door wing movable relative to the furniture carcass, and
the guide system according to claim 1 for guiding the door wing relative to the furniture carcass, preferably wherein the item of furniture includes a receiving compartment for at least partially receiving the door wing.

15. The item of furniture according to claim 14, wherein the door wing is a first door wing, the item of furniture further comprising a second door wing, the second door wing being hingedly connected to the first door wing, wherein the two door wings are movable by the guide system between a first position, in which the two door wings are aligned substantially coplanar to each other, and a second position, in which the door wings are aligned substantially parallel to each other.
